(19) United States
(12) Patent Application Publication
(10) Pub. No.: US 2006/0202928 A1
(43) Pub. Date: Sep. 14, 2006

(54) Active matrix display devices

(75) Inventor: Martin J. Edwards, Crawley (GB)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTRONICS N.V., Eindhoven (NL)

(21) Appl. No.: 10/567,068

(22) PCT Filed: Aug. 4, 2004
(86) PCT No.: PCT/IB04/02638

§ 371 Date: Feb. 3, 2006

(30) Foreign Application Priority Data
Aug. 15, 2003 (GB) 03192143

(51) Int. Cl. G09G 3/36

(52) U.S. Cl. 345/88

(57) ABSTRACT

An active matrix display device, such as an AMLCD, having sets of row and column address conductors (18, 19) connected to an array of colour picture elements (12) arranged in columns of one colour and with adjacent columns being of different colours, and drive means (21, 23, 25) for supplying selection and data signals to the sets of address conductors uses a plurality of serial charge redistribution digital to analogue conversion means (30) to convert multi-bit digital data signals supplied to the column address conductors (19) into analogue voltage levels for use by the picture elements. Each conversion means uses the capacitances of two column conductors between which charge is shared by conversion switches (31). The two column conductors associated with a conversion means are selected to be column conductors associated with picture elements columns of the same colour, preferably adjacent column conductors associated with the same colour. This leads to reduced conversion errors and consequential unwanted display artefacts.

The present invention relates to active matrix display devices, such as active matrix liquid crystal display (AMLCD) devices, and more particularly to active matrix display devices comprising a row and column array of picture elements, sets of row and column address conductors for selecting rows of picture elements and providing data signals to the picture elements of a selected row respectively, drive means for supplying selection signals and multi-bit digital data signals respectively to the set of row address conductors and the set of column address conductors, and in which the multi-bit digital data signals supplied to the column address conductors are converted into analogue voltage levels for use by the picture elements by a plurality of serial charge redistribution digital to analogue conversion means, each conversion means comprising at least first and second capacitances interconnectable by at least one conversion switch and between which charge is shared, and in which the first and second capacitances of a conversion means are provided by the capacitances of two column address conductors.

Such a display device is described in WO 02/21496, whose disclosure is incorporated herein by reference. The provision of the digital to analogue conversion means at least in part effectively within the active matrix circuitry, and utilising components of such, offers many advantages over conventional arrangements in which digital data signals are converted by D/A (digital to analogue) converters located outside the array and the analogue (amplitude modulated) signals supplied by a column drive circuit to the column address conductors. In particular, the column drive circuit can be implemented using purely digital, and relatively simple, circuitry, thereby making it capable of operating at comparatively high speeds, and enabling it conveniently to be integrated on a substrate of the display device together with the active matrix array using thin film transistors, TFTs, as in the active matrix array. The converted voltage is formed directly on the capacitance of the column conductor so that a buffer amplifier is not required to drive the column capacitance. Further, the use of the inherent capacitance of the column conductor to form the converter means avoids the need to provide capacitors within the separate column drive circuit, and, therefore, in the case of a display device with integrated drive circuits, reduces the area required for this circuitry at the periphery of the display device. The signals applied to the column conductor by the external or integrated column drive circuits can be purely digital, or switching signals consisting of two or more discrete voltage levels, thus simplifying the requirements of the column drive circuit.

In this known device, the two column conductors of a D/A conversion means comprise a pair of immediately adjacent column address conductors of the set of column address conductors. In operation one bit of the multi-bit digital data signal is supplied via a first switch to one column conductor of the D/A conversion means and stored as charge on the inherent capacitance of the the column address conductor. This capacitance can be the result of the individual capacitances between the column address conductor and the individual row address conductors where they cross over one another, the capacitance between the column address conductor and, in the case of an active matrix liquid crystal display device, the common electrode carried on a substrate facing the substrate carrying the active matrix array, with the intervening liquid crystal layer acting as dielectric, and also the capacitances presented by the switching devices of the picture elements through which signals on the column address conductor are supplied to the picture element electrodes, which, when the switching devices comprise TFTs as is conventional, usually takes the form of a gate-source capacitance. The column address conductor capacitances may also include a capacitance between the conductor and the picture element electrodes. Generally speaking, the capacitances exhibited by each of the column address conductors will be approximately equal, and as the device has a regular structure the column conductor capacitance is distributed uniformly along the length of the column conductor. Following the charging of the one column conductor capacitance by application of the first, least significant, bit, the first switch is opened and a conversion switch connecting the one column conductor to the other, physically adjacent, column conductor of the D/A conversion means is closed so that the stored charge is shared on both column address conductors. The conversion switch is then turned off and the first switch closed again to allow the next bit of the multi-bit data signal to be used to charge the one column address conductor again. This is followed by the opening of the first switch and closing of the conversion switch to result again in charge sharing between the two conductors. This cycle is repeated for all subsequent bits of the data signal, so that, following application of the last, most significant, bit and after the final operation of the conversion switch, a voltage level is obtained on both column conductors which is equal and determined by the multi-bit digital data signal.

The other column address conductors of the set are similarly paired, with each pair being used as part of a respective D/A converter circuit, and multi-bit digital data signals are supplied at the same time to respective pairs in similar manner to address picture elements in one row. With this pairing arrangement, the multi-bit digital data signals applied to the column conductors are intended for alternate picture elements in the row and when this conversion process is completed these picture elements are selected, by means of a selection signal applied to a row address conductor associated with these alternate picture elements in the row concerned, thereby turning on their switching devices and transferring the voltages stored on one of the column address conductors of each pair to the associated picture element electrodes. The process is then repeated using data signals intended for the remaining picture elements in the row, with the voltages being established on the column address conductors by conversion being transferred to the picture element electrodes of these other picture elements by means of selection signal applied to another row address conductor associated with these other picture elements. Each row of picture elements in the array is addressed in this fashion in turn.

It is conventional in colour displays such as AMLCDs for columns of picture elements to be of respective colours and for adjacent picture element columns to be of different colours. In an AMLCD, for example, a vertical stripe colour filter layout is often used, with the picture elements in a respective column then being of the same colour, and with adjacent columns of picture elements being of different colours, for example with successive columns across the array producing red, green and blue colour respectively, in repeating fashion. When using the above addressing scheme in such a colour display device it has been found that unwanted display artefacts can occur.

It is an object of the present invention to provide an improved colour display device and of the kind described in the opening paragraph.

It is another object of the present invention to provide a display device of the kind described in the opening paragraph and comprising different colour picture elements in which the above-mentioned problem can be overcome, at least to some extent.

According to the present invention there is provided an active matrix display of the kind described in the opening paragraph, wherein the picture elements in a column are of the same colour and adjacent columns of picture elements are arranged to produce different colours, and wherein the first and second capacitances of a digital to analogue conversion means comprise column address conductors associated with the same colour of picture elements.

Thus, unlike the known arrangement in which the two column conductors used for one D/A conversion means comprise successive, physically adjacent, column address conductors, and consequently associated with different colour picture elements columns, the two column conductors of a D/A conversion means of the invention comprise column conductors associated with columns of picture elements of the same colour. Thus, these will not be directly neighbouring, successive, column conductors.

Preferably, the two column conductors of a D/A conversion means comprise adjacent column conductors associated with the same colour picture elements. In the case of the display device comprising red, R, green, G, and blue, B, picture elements for example, with the picture element columns being arranged in R, G, B, R, G, B etc. sequence, then a pair of column conductors comprising one D/A conversion means will be the n^{th} and (n+3)^{th} column address conductors in the set where n is a whole number and ≧1, and a pair of column conductors comprising another D/A conversion means will be the (n+1)^{th} and (n+4)^{th} column conductors, and so on.

The selection of the column conductors used for a D/A conversion means in this manner serves to ensure that the two capacitances of the conversion means are substantially equal, as required for proper operation of the conversion means. It has been determined that the aforementioned unwanted display artefacts found in the known device are the result of differences in the values of the two capacitances used in a D/A conversion means, and it has been appreciated that such differences tend to be present with physically adjacent column conductors associated with different colour picture elements. By using column conductors associated with the same colour, therefore, it can be expected that such differences in capacitances are at least reduced. This leads to a reduction in conversion errors, and resulting unwanted display artefacts. By also using adjacent column conductors associated with the same colour, then possible differences in capacitance values caused, for example, by processing variations across the array, are also minimised.

An embodiment of active matrix display device, and in particular an AMLCD, in accordance with the invention will now be described, by way of example, with reference to the accompanying drawings, in which:

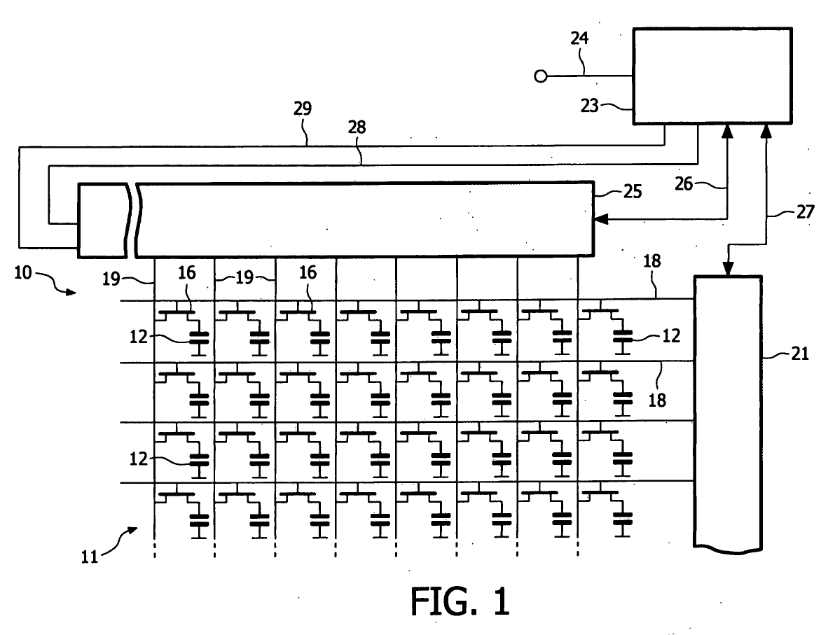

FIG. 1 is a schematic block diagram of an embodiment of AMLCD according to the invention;

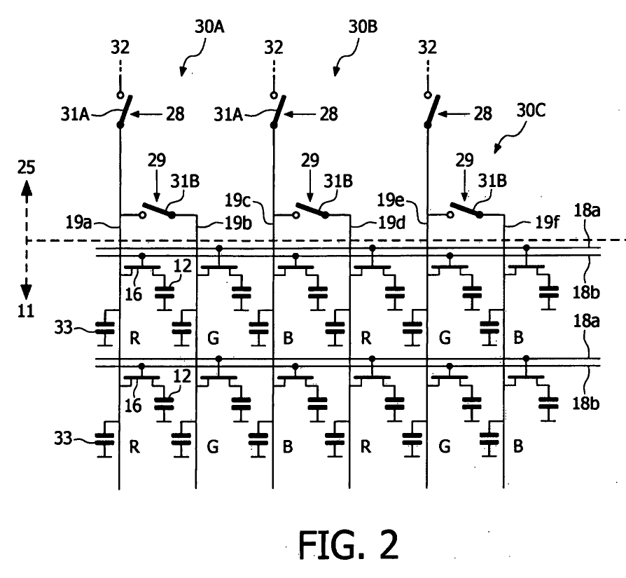

FIG. 2 shows schematically the circuit configuration of part of a known AMLCD;

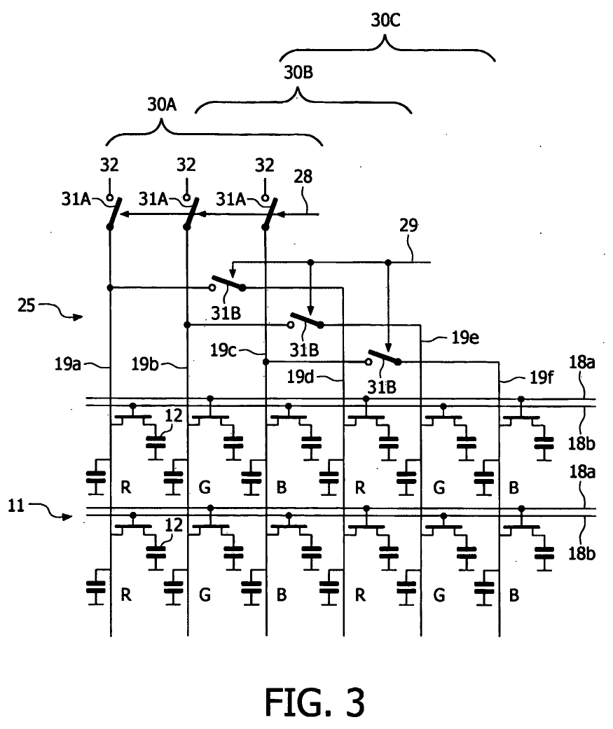

FIG. 3 shows schematically the circuit configuration of part of the display device of FIG. 1; and

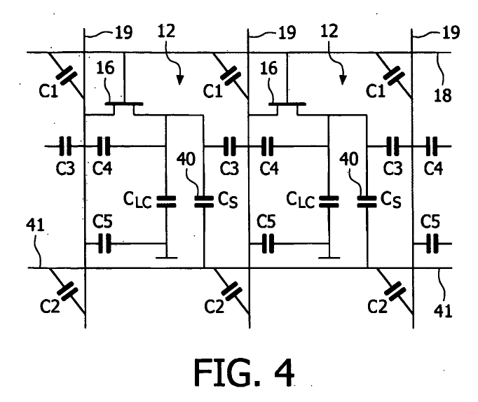

FIG. 4 illustrates various capacitancies present in a typical AMLCD device.

The same reference numbers are used throughout the Figures to indicate the same or similar parts.

Referring to FIG. 1 the active matrix display device comprises a liquid crystal display device having a row and column array 11 of picture elements 12 formed in a display panel 10. The picture elements 12 include liquid crystal display elements formed by spaced electrodes carried respectively on the opposing surfaces of spaced first and second substrates with twisted nematic liquid crystal material disposed therebetween. The display element electrodes on the first substrate comprise respective portions of an electrode layer common to all picture elements in the array while the other electrodes of the display elements of the picture elements comprise individual electrodes carried on the second substrate together with their associated active matrix addressing circuitry. The picture elements 12 include switching TFTs 16 which are connected to crossing sets of row address conductors 18 and column address conductors 19 carried on the second substrate. Drive signals for driving the picture elements are supplied to these sets of conductors from a peripheral drive circuit comprising a row drive circuit 21 and a column drive circuit 25, both of which circuits comprise digital circuitry and are integrated on the second substrate. The row drive circuit 21 is operable to scan the rows of picture elements in turn in each frame period via the row conductors 18 by applying switching waveform signals to the row conductors, which operation is repeated for successive frames, and is controlled by timing signals provided from a timing and control circuit 23 to which an input signal 24 is supplied. The input signal can be either analogue or digital video (picture) data, e.g. a TV signal or a computer video signal. Control and data signals are exchanged between the control circuit 23 and the row drive circuit 21 and column drive circuit 25 along buses 26, 27. The column drive circuit 25 is supplied with digital video data (via an A/D converter if analogue input is used) and operates to apply to the set of column conductors 19, appropriately in parallel for respective picture elements in a row, and in synchronism with scanning of the rows, data signals in a serial multi-bit digital form. The digital signal supplied to the column drive circuit 25 is demultiplexed and samples from a complete line of (video) information are stored in latch circuits of the circuit 25 as appropriate to their associated column of picture elements. As in a conventional display devices, the writing of the (video) information to the picture elements takes placed on a row by row basis in which a line of video information is sampled by the column drive circuit 25 and subsequently written to the picture elements 12 in a selected row via the column conductors, the identity of the selected row being determined by the row drive circuit 21. Unlike conventional display devices, however the video information supplied by the column drive circuit to a column conductor for a picture element is in a serial, multi-bit, digital form rather than analogue (amplitude modulated) form.

The column conductors each have an associated capacitance, which is distributed along the length of said column conductors. Each column capacitance comprises the capacitance between the column conductor 19 and other electrodes within the display device. This column capacitance may include the capacitance between the column conductor 19 and the row electrodes 18 at their cross-over regions, the two being separated by a dielectric layer, the capacitance between the column conductor and the common electrode on the first substrate of the display device, in which case the liquid crystal layer forms the dielectric layer, the source-gate capacitance of the sources of the TFTs 16 of the picture elements associated with the column conductor, and the capacitance between the column conductor and physically close display element electrodes. As the active matrix display has a regular structure, the column capacitance typically will be distributed uniformly along the column conductor.

The display device of FIG. 1 includes D/A conversion means which are provided in part within the column drive circuit 25 and in part by the capacitancies associated with the column address conductors 19.

FIG. 2 shows schematically part of the D/A conversion means in a known display device, as described in WO 02/21496, the D/A conversion means being of the serial charge redistribution type.

In this known arrangement, each D/A conversion means, 30, serves two neighbouring columns of picture elements and three such conversion means, 30A, 30B, and 30C, addressing six successive picture elements 12 in a row, are shown in FIG. 2. It will be appreciated that there will typically be several hundred columns of picture elements in the display device, and therefore many more conversion means, and only a few are shown for simplicity. The colours of the picture elements 12 are denoted by the letters R, red, G, green, and B, blue, and the arrangement of the colour picture elements follows a conventional colour filter layout for AMLCDs using vertical stripes of colour filter material resulting in the picture elements in one column being of one colour and immediately adjacent columns of picture elements being of different colours. Thus, the picture elements in successive columns are in the sequence R, G, B, R, G, B and so on. Each successive column conductor 19 in the set then carries video information, data, signals of a respective colour.

Each D/A conversion means 30 comprises a respective, and separate, pair of directly neighbouring, physically adjacent, column conductors 19, with successive conversion means 30 using successive adjacent pairs of column conductors in the set. Thus, conversion means 30A comprises column conductors 19a and 19b, conversion means 30B comprises column conductors 19c and 19d, etc. The capacitances of the column conductors 19 are represented in FIG. 2 by the capacitors 33, each capacitor 33 denoting the capacitance in the region of a picture element. Considering, for example, conversion means 30A, the two column conductors 19a and 19b are connected at their one ends to a respective serial digital data input 32 in the column drive circuit 25 via conversion switches 31A and 31B, the switch 31B being operable by the control line 29 from the timing and control unit 23 (FIG. 1) to connect the column conductor 19b to the column conductor 19a, and the switch 31A being operable by the control line 28 from the unit 23 to connect the input 32 to the column conductor 19a. Each row of the picture elements is associated with a respective pair of row address conductors, 18a and 18b, with the gates of the TFTs 16 of alternate picture elements in the row being connected to one row conductive 18a and the gates of the TFTs of the remaining picture elements being connected to the other row conductor 18b.

In operation, a row of picture elements is addressed in the following manner. Serial multi-bit digital data is supplied to the inputs 32 in the column drive circuit 25. Considering the conversion means 30A, for example, then in a row address period, in which the picture elements of a row are supplied with their data, a voltage representing the first, least significant, bit of the multi-bit signal for one of the two picture elements in the row associated with the column conductors 19a and 19b is supplied to the input 32 and the switch 31A closed, while switch 31B remains open, so that the capacitance of the column conductor 19a is charged to a voltage level according to that bit. The switch 31A is then opened and the switch 31B closed so that the voltage is shared on both conductors 19a and 19b. Switch 31B is then opened and switch 31A closed again, and a voltage representing the next bit of the multi-bit signal applied to the input 32 causing the column conductor 19a to be charged to a level dependent on this next bit. Switch 31A is then opened and switch 31B closed to share the charge between the conductors 19a and 19b. This procedure is repeated for all subsequent bits of the digital signal.

The other conversion means, 30B, 30C, etc are operated in similar manner at the same time as the conversion means 30A and with the appropriate multi-bit signals applied to their respective inputs 32.

At the end of this procedure, after the last, most significant, bit of the multi-bit signal has been applied and the conversion switch 31B closed, the two column conductors 19 associated with a conversion means are both charged to a required converted voltage level dependent on the applied digital signal. A selection signal is then applied by the row drive circuit 21 to the appropriate one of the two row conductors 18a and 18b associated with the row being addressed, for example, the conductor 18a, to turn on the TFTs 16 of the picture elements connected to that row conductor, whereby the display elements of those picture elements are charged according to the level of the converted voltage on the column conductor 19a, 19c, etc. Alternate picture elements in the row are thus addressed with their respective required voltages.

In the latter part of the same row address period, the above operation is repeated, using multi-bit digital data intended for the other picture elements in the row, and at the end of the conversion phase, through which the pairs of column conductors 19 of each conversion means 30 are charged to a level dependent on the applied digital signals, the other row conductor, 18b, is selected by the row drive circuit 21 to result in the converted voltages being transferred to the display elements of the remaining picture elements in the row.

Successive rows of picture elements in the array are addressed in similar fashion in sequence, in respective row address periods, and this operation repeated for successive frames. Although not shown in FIG. 2, each column conductor 19 may be connected to a switch at its other end, as described in WO02/21496, which is operable to reset the column conductor voltage at the start of each addressing cycle, before the conversion process begins.

Referring now to FIG. 3, there is shown schematically the circuit configuration of a part of the embodiment of display device of FIG. 1 according to the present invention. The picture elements 12 of the array in this embodiment are arranged in the same manner as before, that is, with all the picture elements in a column being of the same colour and adjacent columns being of different colours, so that successive picture element columns form a repeating colour sequence R, G, B, R, G, B, etc. The circuit configuration and manner of its operation are similar to that of FIG. 2, except for the arrangement of the D/A conversion means. Instead of the plurality of D/A conversion means being arranged in a series with each conversion means comprising the capacitances of a respective and separate pair of immediately adjacent column conductors, and with successive conversion means serving successive adjacent pairs of columns of picture elements, each D/A conversion means in this embodiment uses a respective and separate pair of column conductors which comprise adjacent column conductors associated with picture element columns of the same colour, and successive conversion 5 means serve interleaved columns of picture elements. Thus, the D/A conversion means 30A here uses the capacitance of column conductor 19a and the capacitance of column conductor 19d, which is the next column conductor of the set associated with the same colour of picture elements. Similarly, conversion means 30B uses the capacitances of column conductors 19b and 19e, conversion means 30C uses the capacitances of column conductors 19c and 19f, and so on for the remaining D/A conversion means, the plurality of conversion means thus being interleaved with one another.

This arrangement of the D/A conversion means leads a significant improvement in display quality by eliminating, or at least reducing, the possibility of errors in the converted voltages which can occur with the circuit of FIG. 2. The reason for this will now be explained with reference to FIG. 4, which illustrates schematically various capacitances which are typically present in an AMLCD and associated with the column conductors. In FIG. 4, C_{LC} is the capacitance of a display element, C1 represents the cross-over capacitance between individual row and column conductors 18 and 19, and C2 represents the capacitance between an electrode of a picture element storage capacitor 40 (if present) and a column conductor, which storage capacitor is usually connected between the display element electrode of the picture element and a supplementary capacitor line that extends parallel to the row conductors 18. C3 and C4 represent the capacitances between a column conductor 19 and the display element electrodes of adjacent picture elements, and C5 represents the capacitance between a column conductor 19 and the common electrode of the array, which provides the opposing electrodes of the individual display elements.

It is important to the operation of a serial charge redistribution D/A conversion means that the two capacitances forming the conversion means, comprising here the capacitances associated with the two column conductors employed, should have closely matched values. Although in the above description with regard to the circuit of FIG. 2 it has been supposed that the capacitance of the two column conductors forming a conversion means are substantially equal, it has been found that this will not actually be the case and that there can be significant differences. Such differences in the values of the two capacitances lead to errors in the output voltage of the conversion means since charge sharing, and thus the voltages established on the two column conductors of a conversion means upon closing of the switch 31B, will not be equal.

The column conductor capacitance is dependent on the values of C1 and C5 and these values are not necessarily the same for all picture elements but may vary from picture element to picture element over the array due to effects such as alignment and dielectric layer thickness variations. The effect that these variations in C1 and C5 have on the matching of the capacitance of a pair of column conductors can be minimised by forming a conversion means using a pair of column conductors which are located physically close to each other, as in the circuit configuration of FIG. 2. However, this does not apply with regard to the effects of other capacitances.

The capacitance C_{LC} of a display element is dependent on the drive voltage applied to the display element, and therefore varies with the brightness (grey scale) of the display element. For example, C_{LC} for a dark display element may be larger than C_{LC} for a light display element. This means that the column conductor capacitance will depend to some extent on the capacitance of display elements in close proximity. The effect this has on the column conductor capacitance is, though, limited because it is effectively connected in parallel with Cs, the capacitance of the storage capacitor 40, and in series with C3 and C4 when considering column conductor capacitance.

For typical display images from the array of picture elements, differences in brightness levels, and thus display element capacitance, of closely spaced picture elements of the same colour will generally be much smaller than the difference in the capacitance of display elements of two different colours. Thus, by selecting the pairs of column conductors which are to be connected to form a D/A conversion means to be adjacent column conductors associated with the same colour picture elements, as in the arrangement of FIG. 3, rather than simply immediately adjacent column conductors as in the arrangement of FIG. 2, a significant reduction in possible errors is achieved because the difference in the capacitance of column conductors carrying data information of the same colour will typically be smaller than that of column conductors carrying different colour data information.

Apart from the use in the D/A conversion means of different column conductors to those of the FIG. 2 arrangement, the operation of the conversion means in the arrangement of FIG. 3 is generally similar to that of FIG. 2.

Rather than a conversion means comprising the next column conductor associated with the same colour picture elements, it is possible that another column conductor associated with the same colour picture elements, for example the next but one same colour column conductor, but, of course, this would complicate interconnections, and reduce the advantage of using physically close column conductors discussed above with regard to the effects of the capacitances C1 and C5.

The TFTs 16 of the picture elements 12 may be connected to the row conductors 18a and 18b in the same manner as in FIG. 2. However, as shown in FIG. 3, in addition to the connection of the gates of the TFTs 16 of a row of picture elements 12 to the row conductors 18 and 18b alternating along the row, the connection of TFT gates for a column of picture elements are preferably also alternated down the column. Thus, a TFT 16 of a picture element is connected to row conductor 18a and the TFT 16 of a picture element in the same column and in the next row is connected to the row conductor 18G. This will assist in reducing the visibility of any unwanted image artefacts associated with the variation in the lay-out of individual picture elements.

The switches 31A and 31B of a conversion means may be implemented using individual transistors or alternatively CMOS transmission gates.

Although the invention has been described in relation particularly to AMLCDS, it is envisaged that it can be applied to similar advantage in other kinds of active matrix display devices.

From reading the present disclosure, other modifications will be apparent to persons skilled in the art. Such modifications may involve other features which are already known in the field of active matrix display devices and component parts therefor and which may be used instead of or in addition to features already described herein.

1. An active matrix display device comprising a row and column array of picture elements, sets of row and column address conductors for selecting rows of picture elements and providing data signals to the picture elements of a selected row respectively, drive means for supplying selection signals and multi-bit digital data signals respectively to the set of row address conductors and the set of column address conductors, in which the multi-bit digital data signals supplied to the column address conductors are converted into analogue voltage levels for use by the picture elements by a plurality of serial charge redistribution digital to analogue conversion means, each conversion means comprising at least first and second capacitances interconnectable by at least one conversion switch and between which charge is shared, and in which the first and second capacitances of a conversion means are provided by the capacitances of two column address conductors, wherein the picture elements in a column are of the same colour and adjacent columns of picture elements are of different colours, and wherein the first and second capacitances of a digital to analogue conversion means comprise column address conductors associated with the same colour of picture elements.

2. An active matrix display device according to claim 1, wherein the two column conductors of a conversion means comprise adjacent column conductors associated with the same colour picture elements.

3. An active matrix display device according to claim 1, wherein for each conversion means the picture elements in a row associated with the conversion means are connected to different row address conductors.

4. An active matrix display device according to claim 3, wherein the picture elements in a column are connected alternately to the different row address conductors.

5. An active matrix display device according to claim 1, wherein the device comprises a liquid crystal display device.
